(19) United States
(12) Patent Application Publication
(10) Pub. No.: US 2014/0263099 A1
(43) Pub. Date: Sep. 18, 2014

(54) GRAVITY FILTER ASSEMBLY WITH REUSABLE SHROUD

(71) Applicant: Whirlpool Corporation, (US)

(72) Inventors: Ginger E. Patera, Saint Joseph, MI (US); David P. Cooper, Kalamazoo, MI (US); Steve Huda, Shelton, CT (US)

(73) Assignee: Whirlpool Corporation, Benton Harbor, MI (US)

(21) Appl. No.: 13/796,393

(22) Filed: Mar. 12, 2013

(51) Int. Cl. B01D 29/31; C02F 1/00

(52) U.S. Cl. CPC B01D 23/06; C02F 1/003
USPC 210/767; 210/459; 210/232

(57) ABSTRACT

The present invention includes a gravity filter assembly which includes at least one filter media positioned about at least one water inlet pathway. The gravity filter assembly also includes a base. The base has an engagement mechanism which is configured to releasably engage a filter media facing side of a liquid impermeable shroud when a liquid impermeable shroud is positioned over the filter media. The base is sized to fit within an outer perimeter defined by at least one perimeter side wall of the liquid impermeable shroud. Moreover the base includes a top cap section having an outer surface and a filter media facing surface. The filter media facing surface receives the top surface of the filter media. The filter media, base, and top cap section are configured to be removed and replaced without the use of tools.

### BRIEF SUMMARY OF THE INVENTION

One aspect of the present invention includes a gravity filter assembly that includes at least one filter media, a base and a top cap section. The at least one filter media has a perimeter and is configured to remove one or more impurities from a liquid, typically water. The base has a substantially solid center portion, a peripheral portion about the center portion that typically contains or is proximate one or more liquid outlets. The base also has a filter media facing side that is typically adhesively engaged with the filter media and receives the filter media within a perimeter defined by at least one upwardly extending perimeter side wall that extends around at least substantially the entire perimeter of the base, more typically around the entire perimeter of the base. The top cap section has an outer top surface and an opposing filter media facing surface. The filter media facing surface is typically adhesively engaged and receives the top surface of the filter media such that the top surface of the filter media is within at least one downwardly extending perimeter side wall that extends around at least substantially the entire perimeter or the entire perimeter of the outer top surface of the top cap section. The gravity filter assembly is configured to receive a liquid to be treated through a liquid inlet on the outer top surface of the top cap section such that the liquid passes through the top cap section, at least a portion of the filter media, and is dispensed by only the force of gravity through an outlet defined by a space beyond the perimeter of the filter media and beyond the perimeter the base or an outlet within the peripheral portion of the base.

Another aspect of the present disclosure is generally directed to a gravity fed water filter. The gravity fed water filter typically includes a water impermeable shroud having a top surface with at least one aperture therein and a filter media covering wall engaged with the top surface extending downwardly therefrom wherein the filter media covering wall has an inwardly facing side and an outwardly facing side and a filter core. The filter core typically includes: at least one filter media positioned about at least one water inlet pathway and having a bottom surface and a top surface; a base having a water impermeable shroud engagement mechanism configured to releasably engage the inwardly facing side of the water impermeable shroud when the shroud is positioned over the filter media and into engagement with the water impermeable shroud engagement mechanism and a filter media facing side; and a top cap section having an outer surface with a water inlet and a filter media facing surface where the filter media facing surface receives the top surface of the filter media. The base is typically sized to fit within an outer perimeter defined by the filter media covering side wall of the water impermeable shroud. The gravity filter assembly is configured to receive water through the aperture of the top surface such that water is received within the water inlet pathway of the filter media, passes radially outwardly through the filter media and dispensed through the space between the shroud and the base.

Yet another aspect of the present disclosure is generally directed to a method of filtering water comprising the steps of: (1) providing a gravity fed water filter that has: a water impermeable shroud having a top surface with at least one aperture therein and a filter media covering wall engaged with the top surface extending downwardly therefrom wherein the filter media covering wall has an inwardly facing side and an outwardly facing side; and a first filter core. The first filter core typically includes at least one filter media positioned about at least one water inlet pathway and having a bottom surface and a top surface; a base having: a perimeter; a water impermeable shroud engagement mechanism; and a filter media facing side; and wherein the base is sized to fit within an outer perimeter defined by the filter media covering side wall of the water impermeable shroud; and a top cap section having an outer surface with a water inlet and a filter media facing surface wherein the filter media facing surface receives the top surface of the filter media; (2) placing, by hand and without the use of tools, the water impermeable shroud over the first filter core such that it covers the filter media and comes into frictional engagement with the water impermeable shroud engagement mechanism; (3) engaging the inlet of the top cap section of the first filter core with a water source; (4) filtering water received by the inlet to form filtered water; (5) dispensing the filtered water out an outlet defined by the space between the base and the water impermeable shroud into a treated water reservoir.

The method of the present disclosure also typically includes the steps of disengaging the gravity fed water filter assembly from the water source by hand and without the use of tools; disengaging the water impermeable shroud from the first filter core by hand and without the use of tools; providing a second filter core that is typically constructed like the first filter core, more typically identical to the first filter core. The second filter core typically includes: at least one filter media positioned about at least one water inlet pathway and having a bottom surface and a top surface; a base having a water impermeable shroud engagement mechanism and a filter media facing side configured to receive the filter media where the base is sized to fit within an outer perimeter defined by the filter media covering side wall of the water impermeable shroud; and a top cap section. The method of the present disclosure may also include the step of placing, by hand and without the use of tools, the water impermeable shroud over the second filter core such that it covers the filter media and comes into frictional engagement with the water impermeable shroud engagement mechanism.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is an exploded perspective view of the gravity filter assembly having the liquid impermeable shroud removed to further illustrate the filter core;

FIG. 2 is a perspective view of the assembled gravity filter assembly;

FIG. 2B is a bottom view of the assembled gravity filter assembly;

FIGS. 3A-C are perspective views of multiple aspects of the base of the gravity filter Assembly;

FIG. 4 is an exploded view of a gravity filter assembly according to an aspect of the present disclosure;

FIG. 5 is an exploded view of an alternate aspect of the gravity filter assembly;

FIG. 6 is an exploded view of an alternate aspect of the gravity filter assembly;

FIG. 7 is an upper left perspective view of the filter arrangement in an appliance;

FIG. 8 is a bottom right perspective view of the filter arrangement in an appliance; and

FIG. 9 is an exploded perspective view of the filter arrangement in an appliance.

### DETAILED DESCRIPTION

For purposes of description herein, the terms “upper,” “lower,” “right,” “left,” “rear,” “front,” “vertical,” “horizontal,” and derivatives thereof shall relate to the invention as oriented in FIG. 1. However, the invention may assume various alternative orientations, except where expressly specified to the contrary. Also, the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 generally illustrates a gravity filter assembly 10 which includes a liquid impermeable shroud 12 and a filter core 14. The liquid (water or other untreated liquid) impermeable shroud 12 typically has a top surface 16 with at least one aperture 18. While the shroud may have more than one aperture on the top surface, i.e. two, three, four, or more, typically, there is a single aperture 18 defined by the inner edge 20 of the top surface 16. The inner edge 20 may include one or more notched sections 22 that are typically of a pattern that or shape that allows the notches to receive and allow one or more engagement tabs 24 of the filter core to project through the top surface 16 of the liquid impermeable shroud 12. The shroud 12 also has at least one perimeter side wall 26 engaged with the top surface 16 of the shroud 12 and extending downwards therefrom. While preferably one perimeter side wall of tubular shape (circular or substantially circular cross section) is used, the shroud 12 may have any number of sides and cross-sectional shapes. Typically, the cross-sectional shape is designed to match the general cross-sectional shape of the filter core 14 such that the filter core 14 is matingly and snuggly received within the shroud 12. The cross-section of the liquid impermeable shroud could be (1) square such that the shroud has four equal width (and typically equal length) sides; (2) rectangular; (3) triangular; (4) oval; (5) diamond; or (6) conceivably other cross-sectional shapes as well. Moreover, each of the at least one perimeter sidewall 26 has an inwardly facing side 28 and an outwardly facing side 30. The shroud 12 is typically a solid extruded or molded plastic piece. It is typically unitary, but could also be comprised of more than one component such as two halves that snap-fit or are otherwise engaged with one another.

As discussed above, the gravity filter assembly 10 also includes a filter core 14. The filter core 14 typically includes at least one filter media 32 is typically located circumferentially about at least one water inlet pathway 34. The filter media 32 also has a bottom surface 36 and a top surface 38 (see FIGS. 4-7). The filter media is generally an immobilized activated carbon or other filter/treatment media embedded in an absorbent cellulose fiber material. The absorbent cellulose fiber material typically has a fiber diameter of from about 50 nanometers to about 30 microns and more typically from about 15 microns to about 30 microns. An exemplary filter media 32 uses KX Technologies' FACT® media, but filter material from other suppliers or various other filter/treatment materials may be used. The typically used overall filter media configuration is one that has a cylindrical, hollow core that receives an inflow of water from the water inlet with a plurality of rectangular prism-shaped protrusions 40 projecting radially outward about the cylindrical core of the filter media 32, or a pleated filter media configuration.

The filter core 14 also includes a base 42. The base 42 typically has a liquid impermeable shroud engagement mechanism 44 configured to releasably engage the inwardly facing side 28 of the liquid impermeable shroud 12 when the shroud 12 is positioned over the filter core 14 and into engagement with the liquid impermeable shroud engagement mechanism 44. Typically, as shown in FIG. 4, the liquid impermeable shroud engagement mechanism 44 employs a plurality of offshoots or extensions 48 that extend outwardly from the base perimeter 50 beyond the perimeter of the base. Typically, the offshoots 48 are curved, but could also be linear or substantially linear sections extending outwardly from the perimeter of the base perpendicularly or within about five degrees of perpendicular to the base. Such configurations are not typically employed for manufacturing and durability reasons compared to the more typically relative used and employed curved offshoots. On the outwardly facing surface of the offshoots a rounded dimple or other engagement point 52 is typically provided that operably engages inside surface 28 of shroud 12 to frictionally retain the shroud in engagement with the base. Other attachment schemes, such as mating interlocking components forming a compressed or snap fit may also be employed, which are preferably attachable and removable by hand. The engagement points 52 also serve as spacers to define an outlet space where treated water is allowed to flow out of the gravity filter assembly. This configuration allows the shroud 12 to be retained, but readily disengagement from the base by the user, by hand and without the use of tools when the filter cores need to be replaced with another substantially identical or identical filter core. The shroud 12 can be readily disengaged and reengaged with the same or different filter core 14.

The base 42 has a filter media facing side surface which is configured to receive the filter media 32. The base 42 also includes at least one engagement support protrusion 56 extending inwardly from the engagement mechanisms 44. These support protrusions 56 function to center and restrict radial movement of the filter media 14 and secure the media 14 into place. The support protrusions are typically only used when the engagement mechanism's outer facing surface is curved as shown in the drawings. The base 42 is typically sized to fit within an outer perimeter which is defined by at least one perimeter side wall 26 of the liquid impermeable shroud 12. The base also has a filter media facing surface 64 and an outer surface 66. The base has a center or interior portion 68 and a peripheral portion 70 around center/interior portion 68.

As shown in FIG. 1, the filter core 14 typically also includes a top cap section 58. The top cap section has an outer surface 60 and a filter media facing surface 62 and a water reservoir engagement mechanism 72, which is described in more detail in United States Patent Application Publication No. US 2012/0067803 A1, the entire disclosure of which is hereby incorporated by reference. The individual components of the filter core 14, the at least one filter media 32, the base 42, and the top cap section 58 are typically engaged with one another by one of more waterproof non-toxic adhesives, in particular polyethylene. The base 42 may be adhered to the filter media 32 by a glue wall disposed around the perimeter of the interior portion 68 of the base 42. The filter media facing surface of the top cap section 62 receives and engages the top surface 38 of the filter media 32 and the outer surface of the top cap section 62 engages the inwardly facing side 28 of the top surface 16 of the liquid impermeable shroud 12. The top cap section 58, as shown in FIG. 1, includes a plurality of engagement tabs 24 to engage the liquid impermeable shroud 12 by receiving the liquid impermeable shroud's top surface 16 when the shroud is placed over the filter core 14. The engagement tabs 24 rotationally engage the basin filter engagement system 74 of a water basin 76. The top cap section 58 is configured with the water basin engagement mechanism 74 in order to engage the gravity filter assembly 10 with an appliance or water dispensing system or basin 66.

Alternatively, the filter assembly 10 may be assembled using thermal bonding. During the thermal bonding process, the top cap section 58 and the base 42 are installed in a fixture (not shown) with the filter media 32 placed separately between them. The top cap section 58 and the base 42 are then heated up to a degree high enough to cause the plastic to become fluid or soft. The fixture then brings the base 42 and the top cap section 58 to the filter media 32 suspended between then and the filter media 32 is bonded to the top cap section 58 and the base 42.

FIGS. 8 and 9 show how gravity filter assembly 10 comes into engagement with the appliance or water supply system 76. The gravity filter is inserted into engagement with the basin filter engagement system by hand and without the use of tools such that the engagement tabs 24 rotate such that the lip 78 fits within the inside cavity portion 80 of the generally C-shaped engagement tabs 24. An O-ring 82 is typically used to facilitate a water tight seal between the gravity filter 10 and the basin 76. A by-pass disk 82 may be employed that rotates to allow water flow from the basin to flow through apertures 84 in both the filter engagement system and the by-pass disk when a gravity filter is engaged. The by-pass disk rotates as the filter 10 is installed (also typically by rotating) such that the apertures in the filter engagement system and by-pass disk align or substantially align or otherwise allow water flow.

The gravity filter assembly 10, as shown in FIG. 1, is capable of having the entire filter core 14, which includes the filter media 32, top cap 58, and base 42, be removed and replaced by hand without the use of tools. Also, the filter core 14 is removable and replaceable without replacing the entire gravity filter assembly 10 with the liquid impermeable shroud 12 as is the case in prior filter assemblies. This provides a more environmentally friendly overall gravity filter assembly 10.

The gravity filter assembly 10 is configured to receive water, typically from a basin 76 within an appliance, a water basin generally, or from an appliance water dispenser, through an aperture 34 in the top cap section 58 such that water is received into the hollow core 46 of the filter media 32 and passes radially outward through the filter media 32 and is then dispensed through the outlet space 86 (FIG. 2b) between the shroud 12 and the base 42 and into a treated water reservoir basin 88 where the water is stored before being dispensed to a user. Any excess water may also be drained through small base apertures 90 on the base.

FIG. 2A shows the liquid impermeable shroud 12 engaged with the top cap section 58 and the base 42 (FIG. 2B) of the filter core 14. As shown in FIGS. 2A-B, the top cap section 58 of the filter core 14 fits through the aperture 18 on the top surface 16 of the liquid impermeable shroud 12. Moreover, the liquid impermeable shroud 12 operably and releasably engages the engagement tabs 24 located on the outer surface 60 of the top cap section 52. The tabs 24 are received in notched sections 22.

FIGS. 3A-3C show different optional aspects of the base portion 42 of the gravity filter assembly 10. FIG. 3A shows the base portion 42 having a plurality of circular base apertures 90 located on the upwardly extending wall/lip portion 92 of the base adjacent to the engagement or spacer mechanisms 24. FIG. 38 shows another embodiment of the base 42 in which the apertures 90, which are typically circular, but could be any shape are located on the bottom of the base 42. FIG. 3C shows these apertures 90 not circular in shape, but having a rectangular slotted shape. These are meant to be exemplary embodiments only and these apertures 90 may be in various different shapes, sizes, and arrangements. The apertures function to drain excess water from the base that might otherwise stagnate within the base 42 due to the walls 92 of the base 42.

FIG. 4 shows an exploded front perspective view of the gravity filter assembly 10 as shown in FIGS. 2A-B. Moreover, FIG. 4 shows the filter media 32, the base 42, and the top cap section 58 which includes a plurality of engagement tabs 24.

FIG. 5 shows the same exploded view of FIG. 4 with an alternate embodiment of the base 42. In the center of the base portion 42, is a raised portion 94 which engages with the filter media 14 in order to hold the filter media 14 in place. In this figure, the raised portion is a cylindrical post. This raised portion 94 may be a slim post; a cylinder, as shown in FIG. 5; conically shaped, as shown in FIG. 6; or any other shape one of ordinary skill in the art would use to help secure the filter media 32 to the base 42. The raised portion 94 may also function to increase water flow from the filter media 32 into the base 42 where it is then released through the outlet space 86 and/or base apertures 90. The raised portion would typically be constructed to matingly engage the hollow core of the filter media 46 and typically would be of minimal height. Moreover, in a separate embodiment, or combined with any of the previous base embodiments, the raised portion 94 may cover some or up to all of the filter media facing surface of the base. The base 42 may be tapered to angle the water into a desired direction.

The water pathway begins in the water supply system 76, shown in FIG. 8, and enters the inlet 34 through the top cap section 58 and into the filter media 32, using gravity, where the water is then filtered and dispensed into the gravity filtered water reservoir/basin 88. The water is stored until being dispensed to a user out the piping/water pathway 96 and into a beverage container 98. The piping may extend to a dispenser in the door of the appliance accessible from outside the appliance by the user.

Other variations and modifications can be made to the aforementioned structures and methods without departing from the concepts of the present disclosure. These concepts, and those mentioned earlier, are intended to be covered by the following claims unless the claims by their language expressly state otherwise.

What is claimed is:

1. A gravity filter assembly comprising:
at least one filter media having a perimeter and configured to remove one or more impurities from a liquid;
a base having a substantially solid center portion, a peripheral portion about the center portion containing or proximate one or more liquid outlets, a filter media facing side that is engaged with the filter media and receives the filter media within a perimeter defined by at least one upwardly extending perimeter side wall that extends around at least substantially all of the perimeter of the base; and
a top cap section having an outer top surface and an opposing filter media facing surface wherein the filter media facing surface is engaged and receives the top surface of the filter media such that the top surface of the filter media is within at least one downwardly extending perimeter side wall that extends around at least substantially all of the perimeter of the outer top surface of the top cap section; and
wherein the gravity filter assembly is configured to receive a liquid to be treated through a liquid inlet on the outer top surface of the top cap section such that the liquid passes through the liquid inlet, at least a portion of the filter media, and is dispensed by only the force of gravity radially outwards the filter media perimeter and beyond the perimeter the base, or through an outlet within the peripheral portion of the base.

2. The gravity filter assembly of claim 1 further comprising a liquid impermeable shroud having an inwardly facing side, a top surface with at least one aperture therein defining the liquid inlet and at least one perimeter side wall engaged with the top surface extending downwardly therefrom and extending around the perimeter of the top surface wherein the at least one perimeter side wall has a filter media facing side and an outwardly facing side and wherein the liquid impermeable shroud fits over the filter media and into engagement with an engagement mechanism on the base; and wherein the outer surface of the top cap section engages the inwardly facing side of the liquid impermeable shroud and the top surface of the liquid impermeable shroud forming an outlet space for liquid egress between the base and the liquid impermeable shroud;
wherein the at least one filter media is positioned about the liquid inlet; the base further comprises an engagement mechanism configured to releasably engage the inwardly facing side of the liquid impermeable shroud by hand without the use of tools when the liquid impermeable shroud is positioned over the filter media; and
wherein the gravity filter assembly is configured to receive a liquid to be treated through a liquid inlet on the outer top surface of the top cap section such that the liquid passes through the top cap section and passes radially through at least a portion of the filter media prior to being dispensed through the outlet space.

3. The gravity filter assembly of claim 2, wherein the engagement mechanism comprises a plurality of offshoots from the upwardly extending wall of the base wherein the offshoots have a distal portion that engages the inwardly facing side of the liquid impermeable shroud and wherein the gravity filter assembly is substantially cylindrical.

4. The gravity filter assembly of claim 2 further comprising a reservoir engagement mechanism on an outer top surface of the top cap section that is configured to releasably and operably engage a reservoir and extends through the liquid impermeable shroud when the shroud is positioned over the top cap section, the filter media and the base.

5. The gravity filter assembly of claim 3, wherein the offshoots of the base are chosen from the group consisting of curved offshoots from the wall of the base and linear offshoots from the base and wherein the offshoots further comprise a substantially hemispherical-shaped dimple on the impermeable wall engaging portion of the offshoot and the space between the wall of the base and the inwardly facing side of the liquid impermeable shroud define a treated liquid outlet wherein the treated liquid is liquid that has been filtered by the at least one filter media.

6. The gravity filter assembly of claim 5, wherein the peripheral portion of the base further includes one or more water outlets.

7. The gravity filter assembly of claim 2, wherein the base is downwardly tapered from the center portion of the base to the peripheral portion of the base and wherein the peripheral portion includes a notch or hole to drain excess water from within the peripheral portion of the base.

8. A gravity fed water filter comprising:
a water impermeable shroud having a top surface with at least one aperture therein and a filter media covering wall engaged with the top surface extending downwardly therefrom wherein the filter media covering wall has an inwardly facing side and an outwardly facing side; and
a filter core comprising:
at least one filter media positioned about at least one water inlet pathway and having a bottom surface and a top surface;
a base having:
a water impermeable shroud engagement mechanism configured to releasably engage the inwardly facing side of the water impermeable shroud when the shroud is positioned over the filter media and into engagement with the water impermeable shroud engagement mechanism; and
a filter media facing side; and
wherein the base is sized to fit within an outer perimeter defined by the filter media covering side wall of the water impermeable shroud; and
a top cap section having an outer surface with a water inlet and a filter media facing surface wherein the filter media facing surface receives the top surface of the filter media; and
wherein the gravity filter assembly is configured to receive water through the aperture of the top surface such that water is received within the water inlet pathway of the filter media, passes radially outwardly through the filter media and dispensed through the space between the shroud and the base.

9. The filter of claim 8, wherein the filter core is configured to be disengaged from the water impermeable shroud, disposed of and a second, unused filter core that is identically constructed to the filter core is engaged with the water impermeable shroud and wherein the filter core; the second, unused filter core; and the water impermeable shroud are configured such that the water impermeable shroud engages and disengages both the filter core and the second, unused filter core by hand, without the use of tools.

10. The filter of claim 8, further comprising an engagement mechanism on an exterior surface of the top cap section that releasably and operably engage a water supply reservoir.

11. The filter of claim 8, wherein the outer surface of the top cap section frictionally engages the inwardly facing side and top surface of the water impermeable shroud.

12. The appliance of claim 8, wherein the base includes engagement points extending laterally outwardly from the base that engage the water impermeable shroud and where a space between the perimeter of the base and the inwardly facing side of the water impermeable shroud is a water outlet.

13. The appliance of claim 8, wherein the base has a center portion that is solid and impermeable to water and the base is downwardly tapered from the center portion to a peripheral portion about the center portion and the peripheral portion or a perimeter wall of the base that extends upwardly from the base further includes a draining aperture to drain water.

14. The appliance of claim 8, wherein the base has an upwardly extending wall about the perimeter of the base and the engagement mechanism comprises a plurality of curvilinear or perpendicularly extending portions that project outwardly from the upwardly extending wall of the base that engage the inwardly facing side of the liquid impermeable shroud when the shroud is positioned over the filter core.

15. A method of filtering water comprising the steps of:
providing a gravity fed water filter comprising:
a water impermeable shroud having a top surface with at least one aperture therein and a filter media covering wall engaged with the top surface extending downwardly therefrom wherein the filter media covering wall has an inwardly facing side and an outwardly facing side; and
a first filter core comprising:
at least one filter media positioned about at least one water inlet pathway and having a bottom surface and a top surface;
a base having:
a perimeter;
a water impermeable shroud engagement mechanism; and
a filter media facing side; and
wherein the base is sized to fit within an outer perimeter defined by the filter media covering side wall of the water impermeable shroud; and
a top cap section having an outer surface with a water inlet and a filter media facing surface wherein the filter media facing surface receives the top surface of the filter media;
placing, by hand and without the use of tools, the water impermeable shroud over the first filter core such that it covers the filter media and comes into frictional engagement with the water impermeable shroud engagement mechanism;
engaging the inlet of the top cap section of the first filter core with a water source;
filtering water received by the inlet to form filtered water;
dispensing the filtered water out an outlet defined by the space between the base and the water impermeable shroud into a treated water reservoir.

16. The method of claim 15, wherein the step of filtering water includes passing water from the inlet radially outwardly through the filter media and all of the steps are completed by hand and without the use of tools.

17. The method of claim 15 further comprising the steps of:
disengaging the gravity fed water filter assembly from the water source by hand and without the use of tools; and
disengaging the water impermeable shroud from the first filter core by hand and without the use of tools.

18. The method of claim 17 further comprising the steps of:
providing a second filter core comprising:
at least one filter media positioned about at least one water inlet pathway and having a bottom surface and a top surface;
a base having:
a water impermeable shroud engagement mechanism; and
a filter media facing side configured to receive the filter media; and
wherein the base is sized to fit within an outer perimeter defined by the filter media covering side wall of the water impermeable shroud; and
placing, by hand and without the use of tools, the water impermeable shroud over the second filter core such that it covers the filter media and comes into frictional engagement with the water impermeable shroud engagement mechanism.

19. The method of claim 15, wherein the filter media facing side of the base and the filter media facing surface of the top cap section are both adhesively engaged with the filter media.

20. The method of claim 15 further comprising the step of dispensing the treated water from the treated water reservoir and into a beverage container for consumption and wherein the base further comprises an upwardly extending wall about the perimeter of the base.
